(19) United States
(12) Patent Application Publication
(10) Pub. No.: US 2011/0252001 A1
(43) Pub. Date: Oct. 13, 2011

(54) Mirroring High Availability System and Method

(75) Inventor: Andrew Bensinger, Windermere, FL (US)

(73) Assignee: DSSDR, LLC, Windermere, FL (US)

(21) Appl. No.: 13/081,008

(22) Filed: Apr. 6, 2011

Related U.S. Application Data
(60) Provisional application No. 61/322,226, filed on Apr. 8, 2010.

(51) Int. Cl. G06F 17/00

(52) U.S. Cl. 707/658; 707/E17.005

(57) ABSTRACT

Mirroring systems and techniques are provided that create a copy of a first computer system for backup, failover, or other purposes. More specifically, embodiments provide techniques and systems for creating and using a backup of a complete operational computer system, which may be kept up to date in real-time or near-real-time. The backup may be used to restore a failed system, or made accessible separately, such as by way of a virtual machine or restoration to new hardware.

### CROSS-REFERENCE TO RELATED APPLICATIONS

This application claims the benefit of and priority to U.S. Provisional Application No. 61/322,226, filed Apr. 8, 2010, the disclosure of which is incorporated by reference in its entirety.

### BACKGROUND

Business interruption due to the malfunction or loss of a server at a primary site can be a major problem for large as well as small businesses. Conventional systems attempt to address this issue by using various systems ranging from simple periodic tape drive or disk backups to redundant mirror systems running the operating systems and applications present on the primary systems. Data changes to the primary system can be frequently transmitted to the one or more secondary sites to keep them updated. In the event of a malfunction or loss of a primary site, users are redirected to a fully functional and updated secondary site. It can be expensive to maintain such functioning and synchronized backup sites. Software licenses for operating systems and applications running on the primary site have to be purchased and maintained for the backup site. The backup site has to be operated and maintained by a support staff. Further, not every change to the primary site may be quickly communicated to the secondary sites, or may not be communicated at all. Data updates can be infrequent or unreliable and differences between primary and backup hardware and software (e.g., operating system versions, applications, device drivers, etc.) can mean that the backup may not work at the worst possible time, i.e., when it is needed.

These problems can be especially problematic for smaller businesses, which may not have the budget to maintain fully operational, synchronized backup systems. This can be due to prohibitively expensive redundant hardware, operating system and application licenses and the cost of staffing backup operations. Small businesses have been forced to rely on less effective and efficient backup methods, such as tape backup systems or basic remote data storage resources. Such backups can be insufficient and unreliable and can lead to the loss of data and the interruption of business services.

### BRIEF SUMMARY

A mirroring system can be used to provide a copy of a first computer system for backup, failover, or other purposes. More specifically, embodiments as disclosed herein may provide techniques and systems for creating and using a real-time or near-real-time backup of a complete operational computer system.

A method of providing a mirror may include storing a functional mirror of a first operating computer system in a first computer readable storage, where the mirror includes an operating system, one or more executable application programs, and non-executable user data as stored on the first operating computer system. Changes in the first operating computer system may be tracked, and a plurality of updates provided to the functional mirror of the first operating computer system, where each update, when applied to the functional mirror, causes the functional mirror to be updated to reflect a subsequent state of the first operating computer system. Subsequent to a failure of the first operating computer system, in response to a user request to access the first operating computer system, a user may be provided with access to a functional mirror of the first operating computer system. The updates to the mirror may be provided in real time or near real time. The tracked changes may be block- and/or sector-level changes. Some configurations may use multiple mirrors, where each mirror includes the operating system, executable programs, and non-executable user data. Changes to the first system and/or the first mirror may be tracked, and corresponding updates applied to the second or other mirrors. A user may be provided with access to the functional mirror by, for example, executing the functional mirror as a virtual machine, by restoring the mirror to the first computer system, or various other techniques.

Various embodiments may implement methods that use various combinations of these techniques, and may include additional steps or omit some of the steps or features previously described.

Various embodiments may include systems configured to operate with some or all of the methods disclosed herein, and/or to implement some or all the methods. Other embodiments may include computer-readable media storing instructions that cause a computer system to implement or interoperate with the methods disclosed herein.

Additional features, advantages, and embodiments may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification; illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 shows an example system and data flow in which a functional mirror of a first computer system is created and stored in a second computer system.

FIG. 2 shows a schematic and data flow for a system having multiple copies of a first operating computer system.

FIG. 3 shows examples of file retrieval by a primary system and/or another system.

FIG. 4 shows an example configuration in which a volume has been rendered inoperable or inaccessible on the first system and a mirror volume can be accessed or mounted to replace the failed volume

FIG. 5 shows an example system and data flow in which a first system is restored by way of replacement with a stored replica.

FIG. 6 shows an example system and data flow for restoring a failed system in which a new system is the same hardware or uses restored hardware previously used in the first system.

FIG. 7 shows an example process for generating and using a functional mirror of a first computer system.

### DETAILED DESCRIPTION

Cost-effective and efficient data backup and recovery techniques and systems are provided. The systems and techniques disclosed herein can provide near-real time data backup and recovery for minimization of business interruption resulting from data system failure without the high costs of a conventional live, redundant, mirror backup system. The subject matter disclosed herein also may allow for business systems to be reliably and efficiently backed up, without requiring a complete copy of the system to be operational at the same time as the original. Thus, the disclosed systems and techniques may avoid incurring additional license fees or other overhead that would typically be required to maintain two complete, simultaneously-operating systems.

In some configurations, a mirroring tool or technique may perform either a block level or sector by sector level copy of a first computer system, such as a server or workstation, which may include one or more physical or logical volumes, to a second computer system. The second system may include, for example, one or more iSCSI targets, local volumes, direct attached storage (USB, eSATA, or any other storage system), or a combination thereof. The mirror may be, for example, an exact replica containing the native operating system file system, or proprietary readable/accessible through an interpreter. The mirror also may include applications installed on the native operating system and/or non-executable data. That is, it may be a complete, functional copy of the entirety of the first computer system, such that when restored to the first computer system or another equivalent or similar system, it will provide the same operating system, applications, and data that would be available on the first computer system.

A communications method protocol used to transfer data to the second system may include, for example, I-SCSI, eSATA, Ethernet, or any other known or derived computer communications mechanisms or combinations thereof. The Storage B system may use or include, for example, iSCSI, Network, USB, eSATA, external or any other known or derived storage system or combinations thereof.

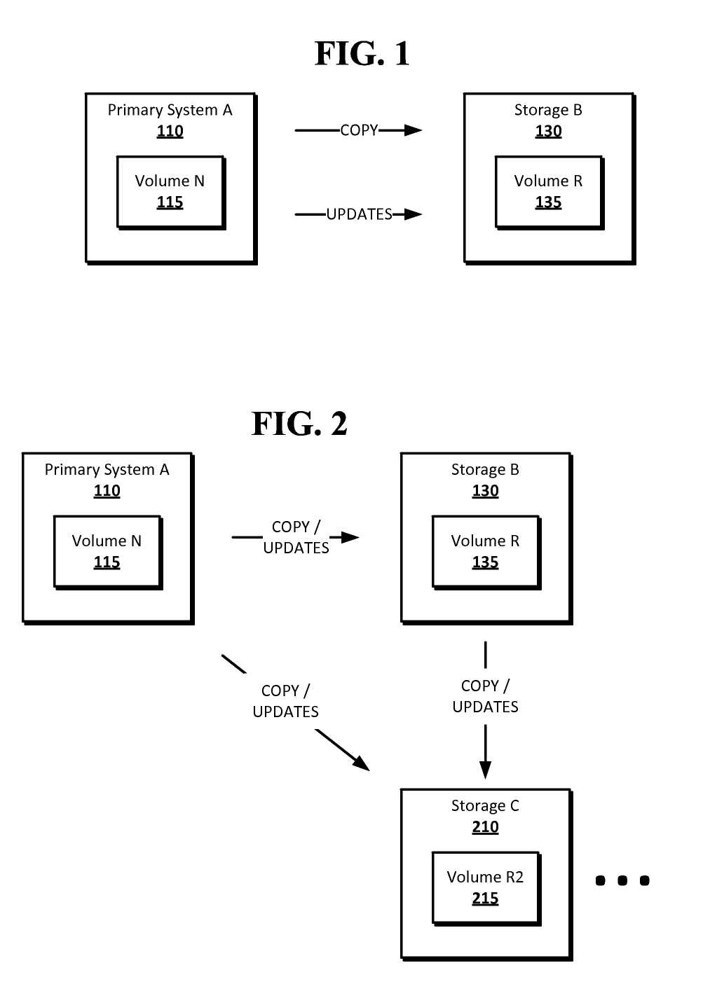

FIG. 1 shows an example system and data flow in which a functional mirror of a first computer system is created and stored in a second computer system. A primary system (“System A”) 110 may include one or more volumes 115. The volumes may be physical, logical, or combinations thereof, and may store a functional operating system, one or more applications executing on the operating system, and/or non-executable data. A copy of the primary system 110 may be created and stored in a second computer system (“Storage B”) 130. The second system 130 may be local to the primary system, or may be located remotely and accessed via, for example, a computer network such as an intranet or the Internet. The copy may be a block-level copy, sector-level copy, or any other appropriate copy of the primary system. For example, all the data, whether executable or non-executable, stored on the one or more volumes 115 that make up the primary system 110 may be copied to a replication volume 135 in the second computer system 130. Various techniques may be used to effectuate the actual data copy, such as Microsoft VSS or similar “hot copy” techniques. The stored copy of the primary system 110 may be referred to as an image, a mirror, or a copy. For example, the stored copy may be an image that can be run in or as a virtual machine that replicates the primary system. As another example, the stored copy may be a mirror that can be restored to a hardware system similar or identical to the hardware of the primary system, so as to provide a functional duplicate of the primary system.

The stored copy may be updated as the primary system changes. For example, a new application may be installed on the primary system, an application or the operating system of the primary system may be updated, or the non-executable data stored by the primary system may be updated. To account for these and other changes to the primary system 110, embodiments as disclosed herein may track block- and/or sector-level changes to the primary system. Incremental or “delta” updates or any derivative or alteration to the primary system 110 may then be provided to the replica at the second system 130, so as to provide real-time, near-real-time, or periodic updates to the stored copy of the primary system. Hence, the stored copy may be kept in synchronization with the primary system. As used herein, a process is considered to occur in “real-time” if the process occurs immediately other than negligible delays due to, for example, physical limits on the speed with which data may be transferred between two points. As a specific example, the copy of the primary system stored at the second system may be kept up to date in real time if a change to the primary system propagates to the stored copy as soon as it occurs at the primary system, other than the relatively minimal delay inherent in the communication required to transfer data from the first system 110 to the second system 130. In this case, the second system would be described as receiving “real-time” updates of the first system. In general, a “real-time” update to a copy of a first system occurs or is initiated less than 5 minutes, preferably less than 1-5 minutes, more preferably within about 20 seconds to 5 minutes after the corresponding change is completed at the first system. In some cases a “real-time” update may require more time to complete after it is initiated due to physical constraints inherent in communication between the first and second systems, such as where the update requires a large file to be transferred to the second system. Similarly, a “near-real-time” update or other process occurs immediately, other than the type of inherent delay encompassed by a “real-time” update, as well as other relatively minor delays, such as to compress, package, verify, or otherwise process files being transferred to the second system, or due to intentional delay such as to minimize the impact of the data transfer on the mirrored system. A “near-real-time” update to a copy of a system typically occurs or is initiated within a few minutes to a few hours or less, after the corresponding change is completed in the system. Near-real-time updates may be used, for example, in configurations where it is desirable to have a minimal or infrequent impact on the system, such as where the copying process may require processing resources that are otherwise needed within the system.

In an embodiment, multiple copies of the primary system may be created and stored. For example, local and remote mirrors may be used, such as to mitigate against a failure of the primary system caused by localized conditions. More generally, any number of replicated copies of the primary system may be created and maintained, and each copy may be local or remote to the primary system. The copy and update process described with respect to FIG. 1 may then be applied to each copy.

FIG. 2 shows a schematic and data flow for a system having multiple copies of a first operating computer system. As described with respect to FIG. 1, a first system 110 can be replicated and a copy of the system stored at a second computer system 130 and updated as described with respect to FIG. 1. A third system 210 (“Storage B”) can include one or more computer readable storage volumes 215, as previously described with respect to the volumes 115, 135 at the first and second systems. The same process described with respect to the first system 110 in FIG. 1 may be applied to the copy at the second system 130, which is then replicated to a third location 210 (“Storage C”). The third system 210 can be local or remote to the first system 110, and may be local or remote to the second system 130. The first system 110 also or alternatively may be independently copied to the third system 210 and/or other systems using the same mechanisms described with respect to FIG. 1. The data on the second system 130 also may be backed up, copied, or otherwise replicated to the third system 210 using file-, block-, and/or sector-level back up techniques or any combination or derivative thereof. The process of replicating the first and/or second systems 110, 130 to a third system 210 may be repeated any number of times to result in any desired number of stored replicated copies. As previously described with respect to FIG. 1, the replicated copies of the first system stored at the second, third, and/or other systems may be updated, and the updates may be made in real time or near real time.

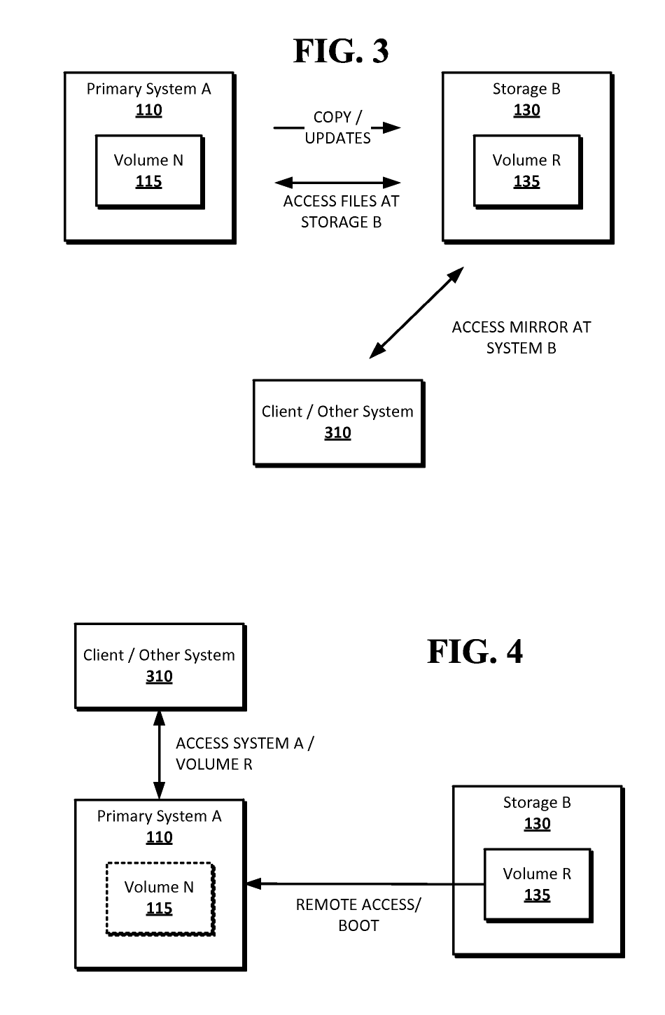

In general, other systems can access data and any information that resides on the replicated copies of the first system. The first system may access data at the stored copies, such as via iSCSI, USB, eSATA, mounted volume, network drive via UNC path, or any other suitable access technique. Alternatively, one or more other systems can access the stored copy to retrieve data via these or any viable communications protocol. Similar access may be available to a third system, if present, and/or to any further derivative of replicated storage. Examples of file retrieval by the Primary System A and/or another system are shown in FIG. 3. As previously described, a first system 110 may be replicated at a second system 130. The first system 110 may then access files stored at the second system 130, such as in the event that the volume N 115, or some or all of the files stored on the volume 115, become damaged or unavailable. Similarly, a client 310 or other system may access the second system 130. In some configurations, the client 310 may knowingly access the second system 130 when it becomes aware that the primary first system 110 is not available or is not operating properly. For example, the first system 110 or another intervening system may notify the client 310 that the first system itself, services or applications provided by the first system, or files stored at the first system are unavailable.

In some configurations, if a volume 115 is rendered inoperable or inaccessible on the first system 110, a mirror volume at the secondary system 130 or another replicated derivative can be accessed or mounted to replace the failed volume allowing for continuity of operations. FIG. 4 shows an example of such a configuration. In the example, a volume 115 at the primary system 110 is unavailable, as indicated by the dashed outline. The mirrored volume R 135 at the second system 130 is mounted, booted, or otherwise made available to the primary system 110. A client 310 or other system accessing the first system 110 may then be provided access to applications, data, and/or operating systems mirrored on the volume R 135. In some configurations, the client 310 may not be notified or otherwise be aware that the primary system 110 is not using the local volume N 115. Example methodologies of mounting a system volume can include, for example, multi-pathed iSCSI, multi-pathed serial over ATA, or any other communications protocol. This may be done by way of, for example, multi-pathing, a boot loader such as PXE boot, or similar techniques to present a volume 135 to the first system 110. System volumes also may be manually presented via a boot loader, such as in configurations where multi-pathing is not used. For nonsystem volumes, a volume on a secondary Storage B 130 or other mirror can be unmasked via a multipath system as described above, or manually presented to the primary system 110. In some configurations, the system volume processes and/or the non-system volume processes can also be performed from or at one or more remote locations, which may be the second system 130 location or another location. As previously indicated, in general the second system 130 and/or the mirror volume R 135 may be local or remote relative to the primary system 110.

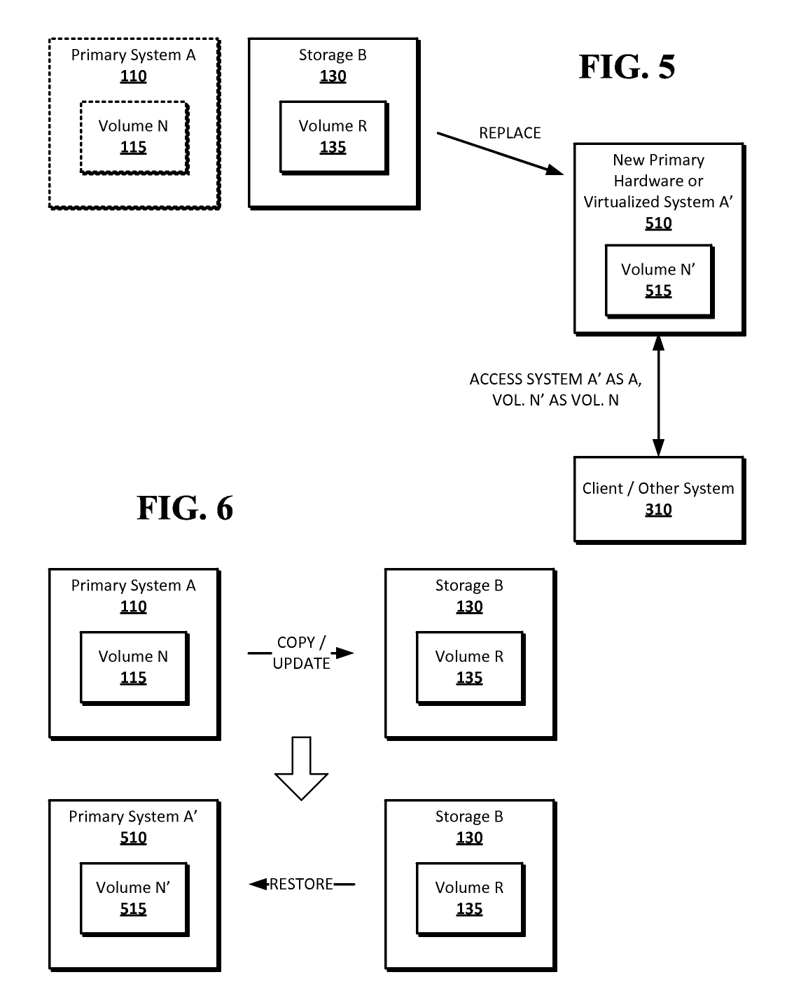

In the event that the first system 110 is rendered completely inoperable or inaccessible (e.g., there is a complete loss of Primary System A), it may be wholly replaced from a stored replica. FIG. 5 shows an example of replacing a first system 110 with a stored replica. The replacement can be either physical or virtual. Various other techniques may be used to replace the Primary System A. For example, new hardware comparable or identical to that used for the primary system 110 may be loaded with a stored mirror to create a new primary system 510. As another example, the files on a boot volume replica containing the hardware abstraction layer (HAL) on any replica may be updated with new drivers for replacement hardware (virtual or physical) to provide “bare metal” restore to hardware dissimilar from the original hardware used in Primary A. A replicated volume 515 may be presented to hardware via iSCSI, PXE boot or any other boot loader and volume presentation layer or similar configuration. If necessary, such as when migrating to virtual or dissimilar systems, the file system may be converted to a different storage format (e.g., NTFS to ext2). Non-system volumes also may be presented to the new primary system, from the original system (e.g., Volume N 115) or from one or more mirrors. In general, these techniques may be performed at any location at which a replica exists. The result of this process may be an active, operable, and accessible volume(s) thus creating a fully operable system(s) for the new hardware. The system may be a complete replica of the Primary System A.

The mirror of the primary system used to generate the new system A′ 510 may be referred to as a “functional mirror” of the first system 110 because it is capable of being run on new hardware and/or as a virtual machine that replicates the operating system, executable applications, and non-executable data of the first system. A “functional mirror” as used herein may be contrasted to a conventional data mirror, in which only non-executable data is copied from a first location to a mirrored storage location. Although a conventional mirror may include files that could be executed by a computer system or operating system, typically such files are merely stored as data, and cannot actually be executed by the data mirror.

The techniques as previously described also may be performed inversely, so as to synchronize a mirrored or now-active volume(s) to the new system's local storage. For example, referring to FIG. 5 a previously-mirrored volume may be synchronized to a local volume at the restored Primary System A′. Once synchronization between the active volume(s) and the Primary System A′ is complete, replica volume(s) may be disconnected and the new system can be booted locally from its storage. That is, the reverse technique may be used to restore a primary system 110/510 using local or remote mirrored volumes, which are then synchronized back to the primary system volumes 115/515 to re-create the entirety of the original system 110. The system's local storage can be any local storage system such as direct attached hardware, SAN's, eSATA, USB, NAS or any derivative. The technique also may be used where the new system 510 is the same or restored hardware previously used in the first system 110, for example where the initial hardware failed and has been restored, to return the actual first system 110 to its original functionality without a lapse in data, service, or accessibility. An example of such a technique is shown in FIG. 6.

In general, the various processes and techniques described with respect to each of FIGS. 1-6 may be performed in any combination and with any number of local and/or remote mirrors. A single process may use each technique described, or may use only a subset of the techniques.

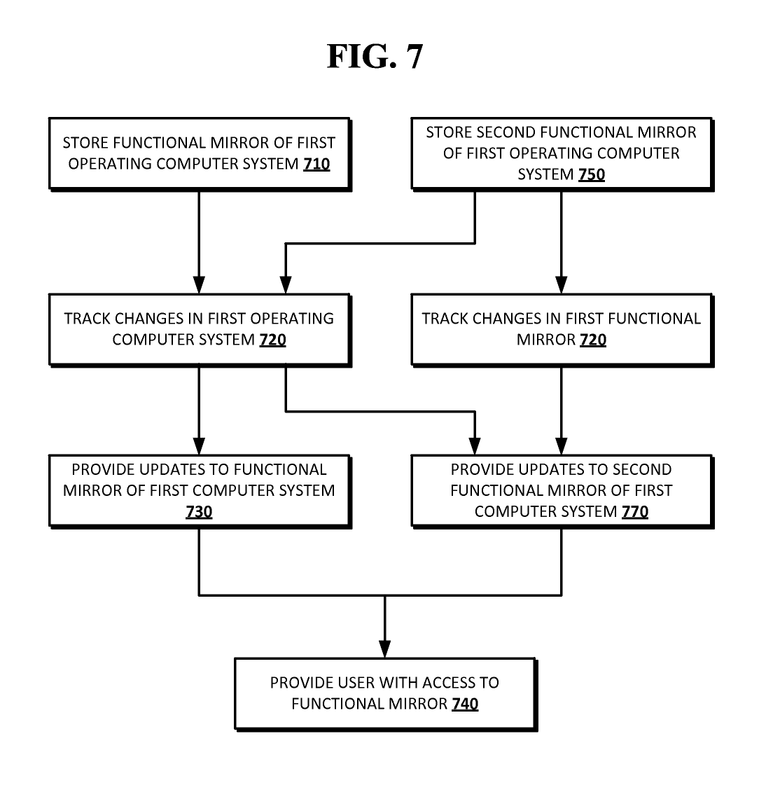

FIG. 7 shows an example process for generating and using a functional mirror of a first computer system, suitable for use with the configurations and systems described with respect to FIGS. 1-6. At 710, a functional mirror of a first operating computer system, such as system 110, may be stored in a first computer readable storage, such as the mirror(s) 130/135, 210/215, etc. The mirror may include an operating system, one or more executable application programs, and non-executable user data as stored on the first operating computer system. At 720, changes in the first operating computer system may be tracked by, for example, block- or sector-level tracking techniques. At 730, updates may be sent or otherwise provided to the functional mirror, for example as shown and described with respect to FIGS. 1-3 and 6. The updates may be provided in real time or essentially real time.

Each update may cause the functional mirror to be updated to reflect a subsequent state of the first operating computer system when applied to the functional mirror. The functional mirror may serve as a substitute for the first operating computer system or be used to restore the first operating computer system. For example, at 740, subsequent to a failure of the first operating computer system, a user may be provided with access to the functional mirror of the first operating computer system after requesting access to the first operating computer system. For example, the user may be provided access to the functional mirror by executing the first functional mirror as a virtual machine. As another example, the user may be provided access to the functional mirror by restoring at least a portion of the functional mirror of the first operating computer system to a hardware component used by the first operating computer system.

In some configurations, more than one functional mirror may be used. For example, at 750 a second functional mirror may be stored in a second computer readable storage. The second functional mirror may include the same operating system, executable application programs, and non-executable user data as stored on the first operating computer system and in the first functional mirror. As with the first functional mirror, at 770 updates may be provided to the second functional mirror, where each update causes the second functional mirror to reflect a subsequent state of the first operating computer system. The updates may be derived from changes to the first computer system, the first functional mirror (e.g., step 760), or both. The second and other mirrors may be maintained serially or at the same time as the first mirror.

Various embodiments may deviate from the illustrative structures described herein. For example, the components and modules described may be combined or further split functionally from the specific structures described. Each of the components may be implemented as a software module or a module that combines software and hardware, and multiple illustrated modules may be combined into a single physical or logical module. Generally, any number of functions may be embodied in any number of modules.

Various embodiments of the methods and systems disclosed herein may include or be embodied in the form of computer-implemented processes and apparatuses for practicing those processes. Embodiments also may be embodied in the form of a computer program product having computer program code containing instructions embodied in tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing the disclosed method. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the method. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the method in accordance with the present invention in hardware and/or firmware. The processor may be coupled to memory, such as RAM, ROM, flash memory, a hard disk or any other device capable of storing electronic information. The memory may store instructions adapted to be executed by the processor to perform the method in accordance with an embodiment of the subject matter disclosed herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

1. A method comprising:
storing a functional mirror of a first operating computer system in a first computer readable storage, the mirror comprising:
an operating system,
one or more executable application programs, and
non-executable user data as stored on the first operating computer system;
tracking changes in the first operating computer system;
providing a plurality of updates to the functional mirror of the first operating computer system, each update, when applied to the functional mirror, causing the functional mirror to be updated to reflect a subsequent state of the first operating computer system;
subsequent to a failure of the first operating computer system, in response to a user request to access the first operating computer system, providing the user access to a functional mirror of the first operating computer system.

2. The method of claim 1, wherein the updates are provided in real-time.

3. The method of claim 1, wherein the updates are provided in near-real-time.

4. The method of claim 1, wherein the tracked changes are block level changes.

5. The method of claim 1, wherein the tracked changes are sector level changes.

6. The method of claim 1, further comprising storing a second functional mirror in a second computer readable storage, the second functional mirror comprising:
the operating system,
the one or more executable application programs, and
the non-executable user data as stored on the first operating computer system.

7. The method of claim 6, further comprising:
tracking changes in the first operating computer system; and
providing a plurality of updates to the second functional mirror of the first operating computer system, each update, when applied to the second functional mirror, causing the second functional mirror to be updated to reflect a subsequent state of the first operating computer system.

8. The method of claim 6, further comprising:
tracking changes in the first functional mirror; and
providing a plurality of updates to the second functional mirror of the first functional mirror, each update, when applied to the second functional mirror, causing the second functional mirror to be updated to reflect a subsequent state of the first operating computer system.

9. The method of claim 1 wherein the user is provided access to the functional mirror of the first operating computer system by executing the functional mirror of the first operating computer system as a virtual machine.

10. The method of claim 1 wherein the user is provided access to the functional mirror of the first operating computer system by restoring at least a portion of the functional mirror of the first operating computer system to a hardware component used by the first operating computer system.

11. A method comprising:
storing a functional mirror of a first operating computer system in a first computer readable storage, the mirror comprising:
an operating system,
one or more executable application programs, and
non-executable user data as stored on the first operating computer system;
tracking changes in the first operating computer system; and
providing a plurality of updates to the functional mirror of the first operating computer system, each update, when applied to the functional mirror, causing the functional mirror to be updated to reflect a subsequent state of the first operating computer system;
wherein the updates are provided in real-time.

12. The method of claim 11, further comprising, subsequent to a failure of the first operating computer system, in response to a user request to access the first operating computer system, providing the user access to a virtual machine executing the functional mirror of the first operating computer system instead of the first operating computer system.

13. The method of claim 11, further comprising storing a second functional mirror in a second computer readable storage, the second functional mirror comprising:
the operating system,
the one or more executable application programs, and
the non-executable user data as stored on the first operating computer system.

14. The method of claim 13, further comprising:
tracking changes in the first operating computer system; and
providing a plurality of updates to the second functional mirror of the first operating computer system, each update, when applied to the second functional mirror, causing the second functional mirror to be updated to reflect a subsequent state of the first operating computer system.

15. The method of claim 13, further comprising:
tracking changes in the first functional mirror; and
providing a plurality of updates to the second functional mirror of the first functional mirror, each update, when applied to the second functional mirror, causing the second functional mirror to be updated to reflect a subsequent state of the first operating computer system.

16. The method of claim 11, wherein the tracked changes are block level changes.

17. The method of claim 11, wherein the tracked changes are sector level changes.
